(19) United States
(12) Patent Application Publication
(10) Pub. No.: US 2025/0111262 A1
(43) Pub. Date: Apr. 3, 2025

(54) ACTIVE MACHINE LEARNING OPERATIONS IN A P2P MESH NETWORK

(71) Applicant: DittoLive Incorporated, San Francisco, CA (US)

(72) Inventor: Christopher PLUMMER, Atlanta, GA (US)

(21) Appl. No.: 18/376,170

(22) Filed: Oct. 3, 2023

(51) Int. Cl. G06N 20/00

(52) U.S. Cl. CPC G06N 20/00

(57) ABSTRACT

Techniques for facilitating active learning of an ML model are disclosed. Raw data is fed to the ML model. The ML model identifies a portion of the raw data as being anomalous. A first peer updates a local version of a database associated with a P2P mesh network. The update includes a new database entry. The new entry reflects the anomalous data and constitutes a database delta change. The first peer propagates the delta change to a second peer in the P2P mesh network. Later, the first peer receives, from the second peer, a second delta change to the database. The second delta change includes label data for the anomalous data. The first peer updates its local database version to include the second delta change, resulting in the anomalous data now being labeled locally. The first peer retrains the ML model based on the newly labeled data.

### BACKGROUND

A “peer-to-peer (P2P) network” (aka “P2P mesh network”) is a type of distributed, decentralized computing architecture that includes multiple peers. A “peer” is one of the computing nodes in the network. A P2P mesh network can employ specialized routing techniques to propagate data throughout the network, including the use of a virtual private network (VPN). P2P mesh networks provide numerous benefits, particularly when Internet connectivity may not be resilient.

P2P mesh networks have many advantages over traditional centralized networks. For instance, a P2P mesh network can optionally avoid governance from a centralized authority. P2P mesh networks are also highly scalable, thereby providing increased resilience and durability for the network as a whole.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for facilitating active learning of a machine learning (ML) model, which is hosted on a first peer included in a peer-to-peer (P2P) mesh network, said method being implemented by the first peer and including: feeding raw data as input to the ML model, wherein the ML model identifies a certain portion of the raw data as being anomalous data; updating a first local version of a database associated with the P2P mesh network, wherein the first local version of the database is hosted by the first peer, wherein said updating includes adding a new entry to the first local version of the database, the new entry being reflective of the anomalous data, and wherein the new entry constitutes a delta change to the database; triggering propagation of the delta change to a second peer in the P2P mesh network; receiving, over the P2P mesh network, a second delta change to the database, wherein the second delta change originates from the second peer and includes label data for the anomalous data; updating the first local version of the database to include the second delta change, resulting in the anomalous data now being labeled in the first local version of the database; and retraining the ML model based on the anomalous data now being labeled.

In some aspects, the techniques described herein relate to a computer system that facilitates active learning of a machine learning (ML) model, the computer system being a first peer in a peer-to-peer (P2P) mesh network, the computer system hosting the ML model, the computer system including: a processor system; and a storage system including instructions that are executable by the processor system to cause the computer system to: feed raw data as input to the ML model, wherein the ML model identifies a certain portion of the raw data as being anomalous data; update a first local version of a database associated with the P2P mesh network, wherein the first local version of the database is hosted by the first peer, wherein said updating includes adding a new entry to the first local version of the database, the new entry being reflective of the anomalous data, and wherein the new entry constitutes a delta change to the database; select a second peer in the P2P mesh network; trigger propagation of the delta change to the second peer via the P2P mesh network; receive, over the P2P mesh network, a second delta change to the database, wherein the second delta change originates from the second peer and includes label data for the anomalous data; update the first local version of the database to include the second delta change, resulting in the anomalous data now being labeled in the first local version of the database; and retrain the ML model based on the anomalous data now being labeled.

In some aspects, the techniques described herein relate to a method for facilitating active learning of a machine learning (ML) model, which is hosted on a first peer included in a peer-to-peer (P2P) mesh network, said method being implemented by a second peer in the P2P mesh network, the second peer including a local version of a database associated with the P2P mesh network, said method including: receiving, over the P2P mesh network and from the first peer, a first delta change that is designated for the database, wherein the first delta change includes a new entry that is addable to the local version of the database at the second peer, and wherein the first delta change corresponds to data that has been identified as being anomalous data; updating the local version of the database at the second peer to include the first delta change; triggering an alert to a user of the second peer; receiving user input, wherein the user input includes label data for the anomalous data, resulting in the anomalous data now being labeled data and no longer being anomalous; updating the local version of the database at the second peer to reflect the labeled data, wherein said updating constitutes a second delta change to the database; and propagating, over the P2P mesh network, the second delta change to the first peer, wherein: the second delta change is configured to enable a different local version of the database, which is on the first peer, to be updated based on the second delta change, and the second delta change is further configured to enable the ML model on the first peer to be retrained based on the labeled data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a suboptimal architecture that may be used to facilitate active learning.

FIG. 2 illustrates an example scenario in which immediate or near-immediate input from a subject matter expert is desired as a part of an active learning event.

FIG. 3 illustrates an improved architecture for facilitating active learning.

FIG. 4 illustrates an example of a peer that includes a P2P mesh network application and database.

FIG. 5 illustrates an example P2P mesh network that involves the use of a big peer residing in the cloud.

FIG. 6 illustrates a federated learning model.

FIG. 7 illustrates an example of a P2P mesh network in which none of the peers are actively connected to the Internet, yet those peers are still able to communicate and synchronize their respective databases.

FIG. 8 illustrates an example of triggering an alert on a peer device of an SME.

FIG. 9 illustrates a scenario in which a quorum consensus with respect to label data is required.

FIGS. 10A and 10B illustrate a flowchart of an example method for facilitating active learning. The perspective described in FIGS. 10A and 10B is from that of whatever peer is hosting the machine learning model.

FIG. 11 illustrates another flowchart of an example method for facilitating active learning. The perspective described in FIG. 11 is from that of the subject matter expert's peer device.

FIG. 12 illustrates an example computer system that may be configured to perform any of the disclosed operations.

### DETAILED DESCRIPTION

Many artificial intelligence (AI) based applications that are built around machine learning (ML) models require a pathway for improving the performance of their overall systems. To do so, ML operations (MLOps) have been developed to try to provide those improvements. For example, MLOps work to close various loops or voids that may exist, such as in data engineering and in application or model delivery. However, MLOps does not itself solve certain challenges that arise with data accuracy, model bias or drift, or even with new data sets in which inputs are not static.

“Active learning” involves the integration of so-called “subject matter experts” (SMEs) who are tasked with resolving issues that the ML models are not able to rectify. For instance, when an ML model identifies an anomaly (i.e. data for which the ML model is not able to label or classify), that anomaly can be sent to an SME for clarification. Involving an SME improves the overall quality of the system by providing real-time insight into trends, anomaly classification, and human observability.

While it may be obvious from a system perspective, the actual technical mechanics of including SMEs into a model's operations are not as obvious. Challenges associated with connectivity, including the distribution of data to be evaluated as well as how to present the data for analysis and review, are typically outside the scope of the data scientists and model engineering realm. In some cases, SMEs may not have easy access to the data or may not have the ability to provide input to the system. For example, in some cases, those SMEs may be remote or mobile or may not be immediately available. For many systems, performance improvements may require immediate or near immediate input from SMEs, even though those SMEs may be globally distributed. Unfortunately, it is the case that significant time delays or latencies are inherently built into traditional systems because SMEs may not be immediately connected with the information that requires resolution. Thus, traditional operations that have time sensitivities have often been disrupted because of the time lag.

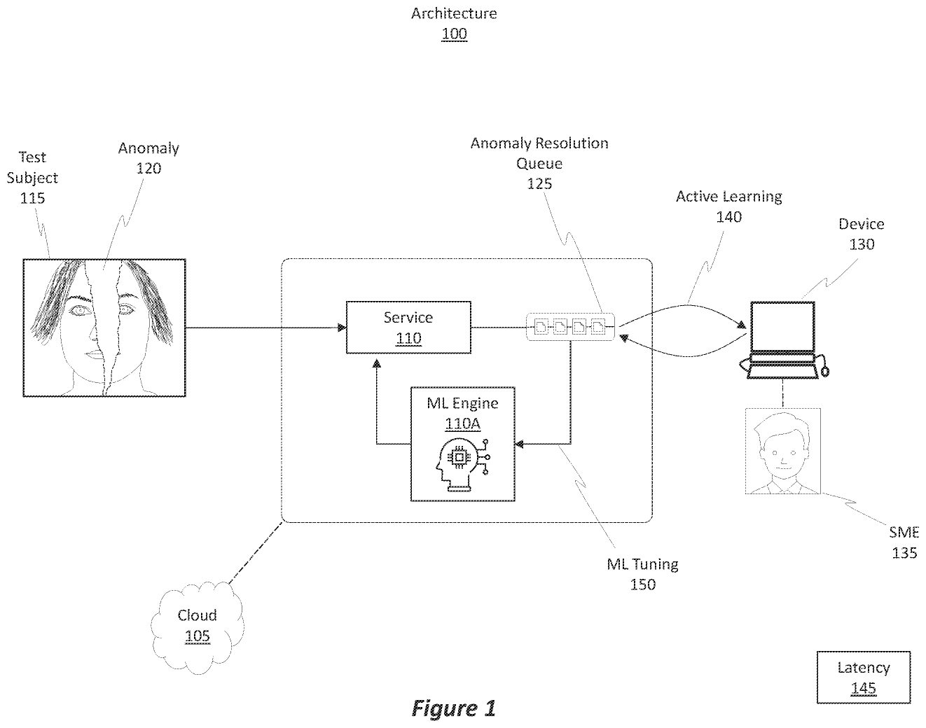

FIG. 1 shows an example architecture 100 that suffers from the challenges described above. In particular, architecture 100 is shown as including a cloud 105 and a service 110 in that cloud 105. Service 110 may include a ML engine 110A.

Service 110 is tasked with providing label or classification data to various test subjects, such as test subject 115. It is often the case, however, that an anomaly 120 arises in which service 110 is not able to properly provide label data. In this particular example, the test subject 115 is an image, and the image has a tear in it. ML engine 110A is not able to classify the tear, so the ML engine 110A identified the tear as an anomaly 120.

With architecture 100, when an anomaly is discovered, service 110 feeds the anomaly into an anomaly resolution queue 125. The anomalies in this queue are ones that are to be resolved by an SME. In this example scenario, a device 130 of an SME 135 is required to login to the cloud 105 to access the anomaly resolution queue 125. The SME 135 then examines the anomaly and attempts to provide label data to the anomaly. Operations in which an SME is tasked with resolving anomalies constitute active learning 140.

One can observe, however, how there may be significant amounts of latency 145 in such a system. For instance, time will be taken to alert the SME, time will be taken for the SME to login to the cloud 105, and time will be taken to provide the label data. If device 130 is not connected to the Internet or to the cloud 105, then SME 135 may not receive a notice of the anomaly for a prolonged period of time. Another challenge may arise if the connection between device 130 and the cloud 105 is not resilient.

Eventually, the goal is for the SME 135 to provide label data for the anomaly. Once that label data is obtained, then ML engine 110A can be retrained or an ML tuning 150 operation can be performed based on the newly acquired label data. As described above, there are various points of potential failure and points at which latency is introduced with architecture 100.

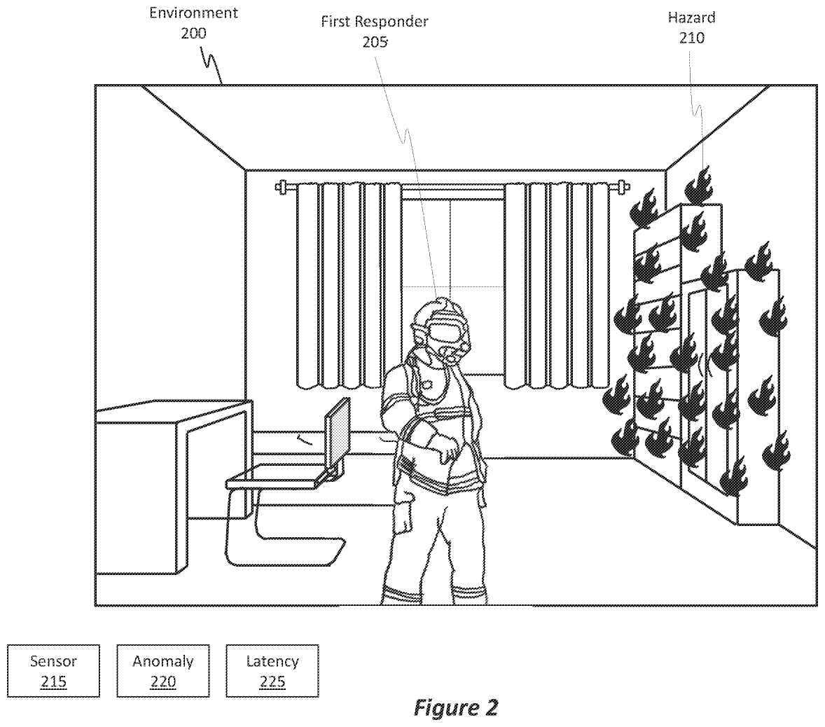

As a more intense example, consider the scenario presented in FIG. 2. FIG. 2 shows an example environment 200 in which a first responder 205 is operating and in which a hazard 210 is occurring. It may be the case that the first responder 205 has on his/her person a sensor 215 to detect the environment's conditions and whether those conditions are life-threatening (e.g., toxic air).

In some instances, a model may operate using the data from the sensor 215. Sometimes, the model may detect an anomaly 220 and not know how to classify or label the sensor's data.

Using architecture 100 of FIG. 1, significant time delays (i.e. latency 225 of FIG. 2) may be introduced while the SME 135 is notified and while the SME 135 responds to the anomaly 220. In the scenario presented in FIG. 2, seconds often matter, so the latency 225 may result in mission failure for the first responder 205. Accordingly, there is a substantial need to improve how active learning is performed, particularly with how anomalous data is delivered to an SME and how the resolution of that anomalous data is returned to the source that detected the anomaly.

The disclosed embodiments provide solutions to the above problems by improving the connection an SME has with respect to the active learning system. For example, the disclosed embodiments generally employ the use of a P2P mesh network database that can be synchronized across all the peers in the P2P mesh network. Each client device operating in the P2P mesh network includes a local version of the database. Updates to the database, including updates involving the identification of an anomaly, are quickly propagated to each of the devices, even when those devices may not be connected to a wide area network (WAN), such as the Internet. An alert can then beneficially be triggered for the SME's device, and the SME can then quickly resolve the anomaly. That resolution may then be propagated to the other devices and may lead to a retraining of the ML model.

Stated differently, the embodiments utilize a unique database synchronization technique to coordinate an active learning workflow. The embodiments facilitate the active learning workflow by distributing anomalies that are detected (including any relevant metadata) in production model environments to one, some, or all potential SMEs so that those SMEs can provide label or classification data for the detected anomaly. The embodiments also beneficially redistribute updated datasets to trigger the training or retaining of an ML model based on the provided label data.

Thus, the disclosed embodiments beneficially utilize a unique database structure and software development kit (SDK) to create a framework for attaching to an MLOps environment, including its datasets. The embodiments are further able to dynamically distribute data (e.g., classification, labeling, bias and trend identification) to SMEs and from SMEs to an ML model. Beneficially, the embodiments are configured to distribute data and to task in an intelligent manner the utilization of the P2P mesh network. Advantageously, synchronization between the local versions of the databases occurs in response to changes to the active learning structure, such as when new data is available or a new insight from an SME is gained.

As some additional benefits, the embodiments provide the framework within an application development ecosystem (e.g., iOS, Android, web) so that functionality can be built for gaining an SME's analysis and input. The embodiments also beneficially provide requisite security of the data and the transaction, including encryption, integrity protection, authentication, and authorization. The embodiments provide the observability required by compliance commitment, including auditing, logging, and trend tracking. Another beneficial feature of the disclosed embodiments relates to the integration of an SME's analysis for data engineering. The embodiments are able to facilitate the movement of the analysis datasets to the SME as opposed to requiring centralization of the analysis workloads, which requires SME connectivity with the Internet.

As mentioned previously, current active learning systems are mostly limited to “labeling” activities within data engineering processing flows and large datasets. While this is useful for transforming and classifying data, it limits the scope of SME integration, as well as potential workflows operationally. The disclosed embodiments can integrate into operational environments and can provide real-time feedback to MLOps by propagating data to the SMEs and by obtaining immediate or near-immediate input from those SMEs. The disclosed embodiments also allow for the ML model or ML model benefits to be integrated into existing applications and services. Accordingly, these and many other benefits, improvements, and practical applications will now be described in more detail throughout the remaining sections of this disclosure.

### Example Architectures

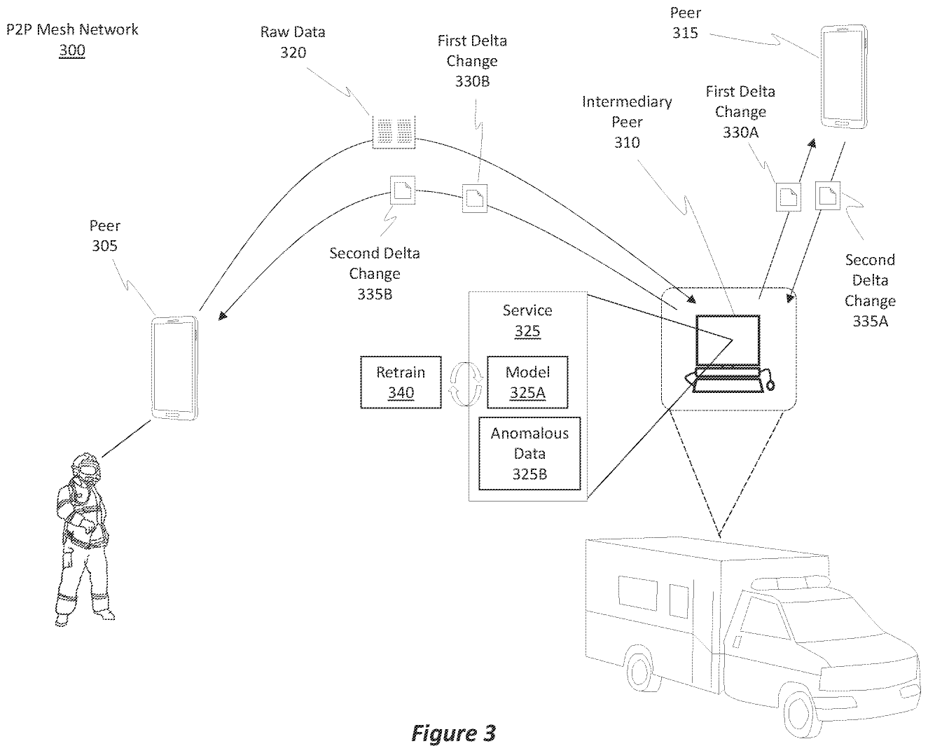

Attention will now be directed to FIG. 3, which illustrates an example P2P mesh network 300 that includes multiple peers, including peer 305, intermediary peer 310, and peer 315. Peer 305 is considered an edge peer in that it is at the very edge of the P2P mesh network 300. By “edge” it is meant that peer 305 is the last peer in a serial chain of peers. In this example scenario, peer 305 does not include robust computational abilities. As a result, the ML model mentioned earlier does not reside on peer 305.

Intermediary peer 310 is considered “intermediary” because it is logically disposed between at least two other peers, such as peer 305 and peer 315. In this example scenario, intermediary peer 310 is included in a first responder vehicle, such as an ambulance. Intermediary peer 310 may include robust computational abilities. As a result, the ML model mentioned earlier can (and does) reside on intermediary peer 310.

Peer 315 is also considered an edge peer. As will be discussed in more detail later, peer 315 is the device of an SME.

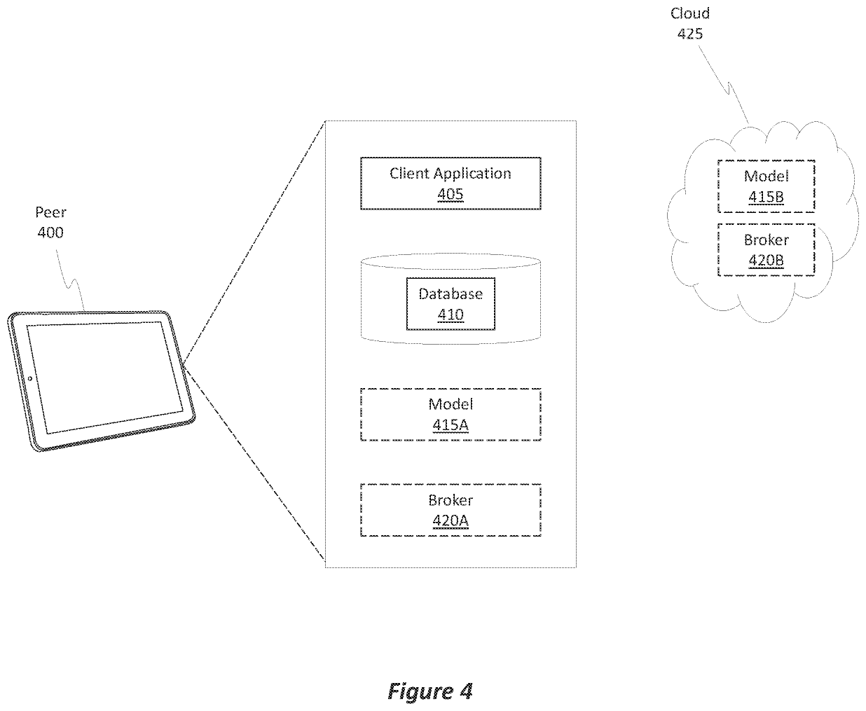

FIG. 4 provides some additional details regarding a peer. FIG. 4 shows a peer 400, which is representative of any of the peers illustrated in FIG. 3. Peer 400 is shown as executing a client application 405 that allows the peer 400 to be included in a P2P mesh network.

Each peer in the P2P mesh network includes a client application (e.g., client application 405) running on that peer. This client application enables the peer to join the P2P mesh network and to provide various other features and functionalities, such as pushing data to another peer or service and receiving data or commands from another peer or service. In some embodiments, the client application incorporates one or more components of an SDK that enable a client application developer to quickly and easily add P2P mesh network connectivity to a device.

It is worthwhile to note that the disclosed P2P mesh networks can optionally operate using an underlying database 410 that can be configured to support any type of operation involving the use of conflict-free replicated data types (CRDT). As used herein, a CRDT refers to a data structure that has certain properties. Those properties include the ability of a unit of data to be replicated across different devices in a network. The properties also include a property in which a replica of an application can be updated independently, concurrently, and even without coordination with other replicas. Another property of a CRDT is that inconsistencies can be automatically resolved. Yet another property of a CRDT is that the replicas of the application are configured in such a manner that there is a guarantee that those replicas will eventually converge or synchronize. Accordingly, the disclosed P2P mesh networks can use CRDT data structures to operate. In some implementations, traditional key: value pair types of databases can also be used, such as perhaps alongside of the CRDT implementations.

Each peer in the P2P mesh network includes a corresponding local version of the database 410. Furthermore, each peer can update the database 410. Such updates will then be propagated to the other peers in the P2P mesh network, resulting in synchronization of the local versions of the database.

Regarding client application 405, each peer in the P2P mesh network implements a corresponding instance of the client application. The client application 405 refers to an application that enables the peers in the P2P mesh network to connect to one another and to optionally provide the CRDT functionality mentioned earlier. The client applications also enable the various peers to receive and send information from one peer to another peer, including a so-called “big peer” that might reside in a cloud environment or a “small peer” (or simply “peer”) in the form of an on-premise device. Thus, as used herein, a “big peer” refers to a computing device or service that operates in the cloud environment, and a “small peer” is a different computing device or service that does not operate in the cloud. These client applications may optionally be on any type of device with any type of operating system with P2P mesh network connectivity implemented using an appropriate SDK.

A connection is formed between the peers. A connection can be formed via any type of transport mechanism, such as, but not limited to, any type of Bluetooth connection, Bluetooth low energy connection, LAN connection, wireless fidelity (Wi-Fi) connection, a Wi-Fi direct connection, an AirDrop connection, a universal serial bus (USB) connection, telecommunications connection, and so on. Bluetooth, Bluetooth low energy, and the LAN are examples of short range wireless connections. Other short range wireless connections can be used as well, such as a near-field communication (NFC) connection.

Data can be passed between the peers. Often, that data includes one of at least three different types of data. These data types include (i) platform data, which can include device log data, (ii) SDK data, and/or (iii) customer data.

Platform data refers to any type of data describing a peer's platform. For instance, platform data can include a peer's friendly name, the peer's operating system data, the peer's device characteristics (e.g., processor data, memory data, bandwidth data, etc.), or any other type of data related to the features and functionality of the peer's operating system and device characteristics. Platform data can also optionally include the device log data. The device log data can include any type of activity data generated or monitored by the peer. This information can include device or application connections, errors, authentication events, and so on.

SDK data refers to the features and attributes of the SDK utilized within the client application installed on the peer (e.g., client application 405). For instance, one device may have one version of the client application while a different device may have a different version of the client application. SDK data includes any details related to the version or operation of SDK components in a client application on a peer.

Client application 405, which may be in the form of an SDK, can also be used to help a user develop his/her own client application. For instance, client application 405 can optionally provide an integrated development environment (IDE) for developing applications.

Customer data refers to data describing the application that is being developed by the user using the client application 405. Customer data can include any type of error message, compiling data, runtime data, telemetry data, raw data, anomaly data, and so on, without limit.

Optionally, the various different peers in the P2P mesh network can be configured to push their platform data, SDK data, and/or customer data through the P2P mesh network to another peer at a predefined frequency, such as perhaps every “x” number of minutes, hours, or days. A secure virtual private network (VPN) may be established by the client application 405 between peer 400 and any other peer.

In some implementations, peer 400 may include a model 415A, such as the ML models discussed earlier. That is, model 415A includes an ML model or ML engine that performs labeling or classification of data, as generally described earlier.

In some implementations, peer 400 may also include a broker 420A. Broker 420A is generally tasked with selecting another peer to send information to, such as an anomaly. To clarify, updates to a peer's data (where the updates may include the anomaly) are typically propagated to all the peers in the P2P mesh network. That being said, it is particularly desirable to transmit the anomaly as quickly and efficiently as possible to an SME. Thus, in some cases, transmission of a database update to an SME may be prioritized over transmission of that same update to other peers in the P2P mesh network. Broker 420A can be tasked with not only identifying the SME but also with prioritizing the transmission of the anomaly data. Further details on the broker 420A will be provided later. Generally, broker 420A can use metadata associated with either the anomaly data or the source of that anomaly data (e.g., raw data) to select which SME or peer is appropriate or desired to receive the anomaly.

In some implementations, model 415B and/or broker 420B may reside in the cloud 425. For instance, model 415B and broker 420B may reside on a big peer that operates in the cloud 425.

Returning to FIG. 3, FIG. 3 shows how peer 305 is associated with a user, such as the first responder described in FIG. 2. In accordance with the disclosed principles, peer 305 may be collecting or generating sensor data. That sensor data, which is illustrated as raw data 320, is shown as being delivered to the intermediary peer 310. In this example scenario, peer 305 has a lower level of computing abilities as compared to the intermediary peer 310, which may (as one example) be a server operating on an ambulance or EMS vehicle for the first responder. In a later example, it may be the case that the edge device has sufficient capabilities to perform certain activities. Further details on that aspect will be provided later.

FIG. 3 shows how the intermediary peer 310 includes a service 325. As used herein, the term “service” refers to an automated program that is tasked with performing different actions based on input. In some cases, service 325 can be a deterministic service that operates fully given a set of inputs and without a randomization factor. In other cases, service 325 can be or can include a machine learning (ML) or artificial intelligence engine in the form of model 325A. Model 325A can operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 325 is a cloud service operating in a cloud environment. In some implementations, service 325 is a local service operating on a local device, such as the peer 310. In some implementations, service 325 is a hybrid service that includes a cloud component operating in the cloud and a local component operating on a local device. These two components can communicate with one another.

Service 325 is generally tasked with receiving the raw data 320 and feeding it to the model 325A. The model 325A analyzes the raw data 320 and attempts to provide label data to the raw data 320. In some cases, the model 325A may detect one or more anomalies and identify those anomalies as anomalous data 325B.

Although not illustrated in FIG. 3, FIG. 4 shows how each peer includes its own corresponding local version of the P2P mesh network database. In accordance with the disclosed principles, service 325 is able to update its local version of the database by adding a new entry into the local version of the database. This new entry is reflective of the anomalous data 325B. Also, the new entry constitutes a delta change to the database.

Because model 325A is unable to resolve the anomalous data 325B, service 325 determines that active learning is warranted. As mentioned previously, active learning generally refers to the process of calling on an SME to help label data that the model 325A was not able to resolve. In accordance with the disclosed principles, service 325 is able to analyze metadata associated with the raw data 320 to determine which, of potentially many, SME is most suited to resolving the anomaly. In some cases, multiple SMEs may be selected, as will be discussed in more detail later. An SME may be selected based on his/her technical qualifications.

Service 325 then propagates the first delta change to all of the peers in the P2P mesh network, with a particular emphasis on propagating the first delta change to the selected SME. To illustrate, FIG. 3 shows a first delta change 330A being propagated to peer 315, which is the peer device of the SME that was selected. Additionally, the first delta change 330B is also being propagated to the peer 305. As a result of the peers receiving the first delta change, the local versions of the database residing on those peers will be updated to include the first delta change. Notice, the first delta change is being propagated through the P2P mesh network even though the peers in FIG. 3 are not shown as being connected to the Internet. Instead, these peers may be connected via other short-range wireless connections, such as Bluetooth.

Peer 315 is associated with an SME who was determined will likely be able to provide label data to the anomalous data 325B, which was reflected by the first delta change 330A. When the first delta change 330A is used to update the local version of the database on peer 315, an alert on peer 315 may be triggered to alert the user of the change to the database. The SME using peer 315 then provides input. This input includes label data for the anomalous data, resulting in the anomalous data now being labeled data and no longer being anomalous.

The local version of the database on peer 315 is also updated to reflect the labeled data. This update constitutes a second delta change to the database. This second delta change is then propagated to the other peers in the P2P mesh network. To illustrate, second delta change 335A is propagated from peer 315 to peer 310. Similarly, second delta change 335B is propagated from peer 310 to peer 305. Each of those peers will then update its corresponding local version of the database, resulting in a global synchronization.

Stated differently, the second delta change is configured to enable different local versions of the database to be updated based on the second delta change. Also, the second delta change is configured to enable the model 325A to be retrained based on the labeled data, as shown by retrain 340. In some implementations, an additional notification can be provided to the user of the original source of the anomaly (e.g., the first responder) to let the user know the status or state of the anomaly. For instance, if the anomaly related to air conditions in a burning building, a notification can be provided to the first responder to let him/her know whether the conditions are hazardous.

From the above example, a skilled person will appreciate how the architecture presented in FIG. 3 solves the issues that were previously present in architecture 100 of FIG. 1. Now, push notifications can be sent directly to a user's peer device, even if that peer is not connected to the Internet. Such a push results in improvements in latency. Similarly, the embodiments avoid the scenario in which the SME must log in to a cloud portal to access anomalous data. Now, the database on the SME's peer device is updated, and the data is made immediately available to the SME. Such operations significantly reduce the lag time or the latency of the architecture 100 of FIG. 1.

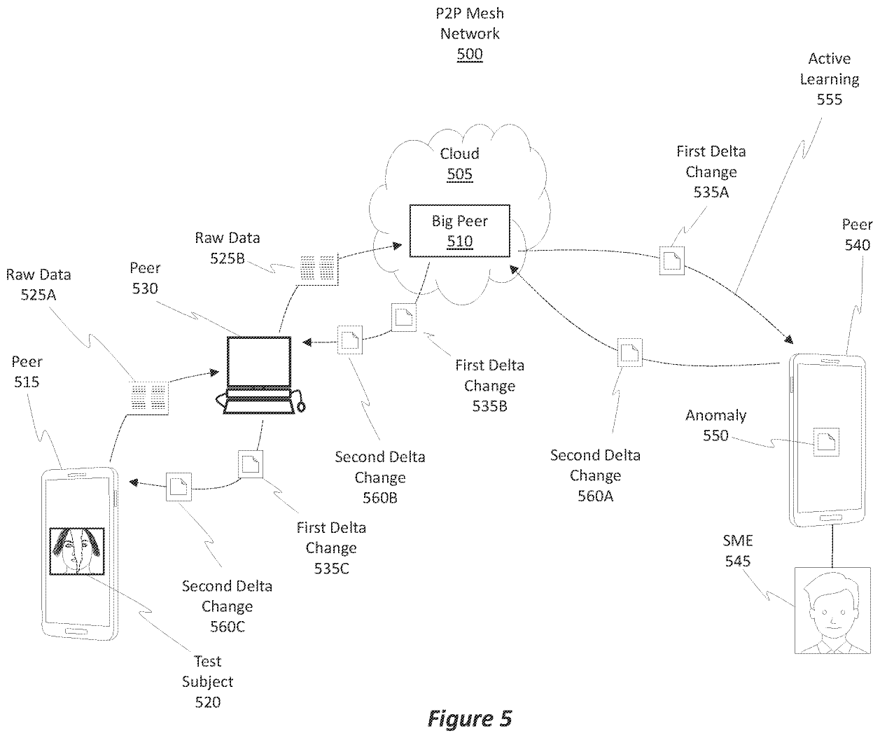

FIG. 3 showed an example scenario in which an intermediary peer 310 was hosting the service 325 tasked with implementing the model 325A. FIG. 5, on the other hand, shows a scenario in which a so-called “big peer” is residing in the cloud and is the entity that hosts the service, which implements the model.

### Big Peer Learning Model

FIG. 5 shows an example P2P mesh network 500 that includes a cloud 505 and a big peer 510 residing in the cloud 505. Network 500 also includes a peer 515, which is collecting data, such as the test subject 520. The collected data is shown as raw data 525A. In this example scenario, peer 515 does not include the model that is used to perform machine learning. As a result, peer 515 transfers the raw data 525A to another peer 530. Peer 530, however, is also not implementing the model. That being said, peer 530 is connected to the cloud 505 and can transmit the raw data 525B to the big peer 510. Notably, peer 515 was not connected to the cloud 505 and thus could not directly transmit the raw data 525A to the cloud 505; instead, peer 530 operated as an intermediary transporting peer to deliver the raw data to the big peer 510.

Although not shown in FIG. 5, big peer 510 includes the model and service that was mentioned earlier. Thus, big peer 510 operates on the raw data 525B using the ML model. If an anomaly is detected, then big peer 510 updates its own local version of the P2P mesh network database by adding a new entry. This new entry is reflective of the anomalous data. This new entry constitutes a first delta change, which is propagated to the other peers in the P2P mesh network 500.

To illustrate, big peer 510 transmits the first delta change 535A to peer 540. Big peer 510 also transmits the first delta change 535B to the peer 530. Peer 530 transmits the first delta change 535C to the peer 515.

Peer 540 is the device of an SME 545. The local version of the database on peer 540 is updated to incorporate the first delta change 535A. The SME 545 is then tasked with analyzing the anomaly 550, which is included in the first delta change 535A. The SME 545 may provide label data to the anomaly 550 as a part of an active learning 555 process.

In response to the SME 545 providing label data to the anomaly 550, a new entry is added to the local version of the database, resulting in an update to that database. This update, which includes the label data, is then propagated to the other peers. For instance, this update is illustrated as being second delta change 560A, which is propagated from peer 540 to the big peer 510. Big peer 510 then propagates the second delta change 560B to the peer 530. Peer 530 propagates the second delta change 560C to the peer 515. Thus, the peers in the P2P mesh network 500 receive updates to their local versions of the database.

Big peer 510, after incorporating the second delta change 560A, then uses that data to retrain the model. Thus, the model receives label data for the anomaly, and the model can now be further trained based on the results of the active learning 555 process. Also, as discussed before, the operations that are performed using the P2P mesh network 500 result in improved efficiency in the active learning process, particularly by reducing latency.

### Federated Learning Model

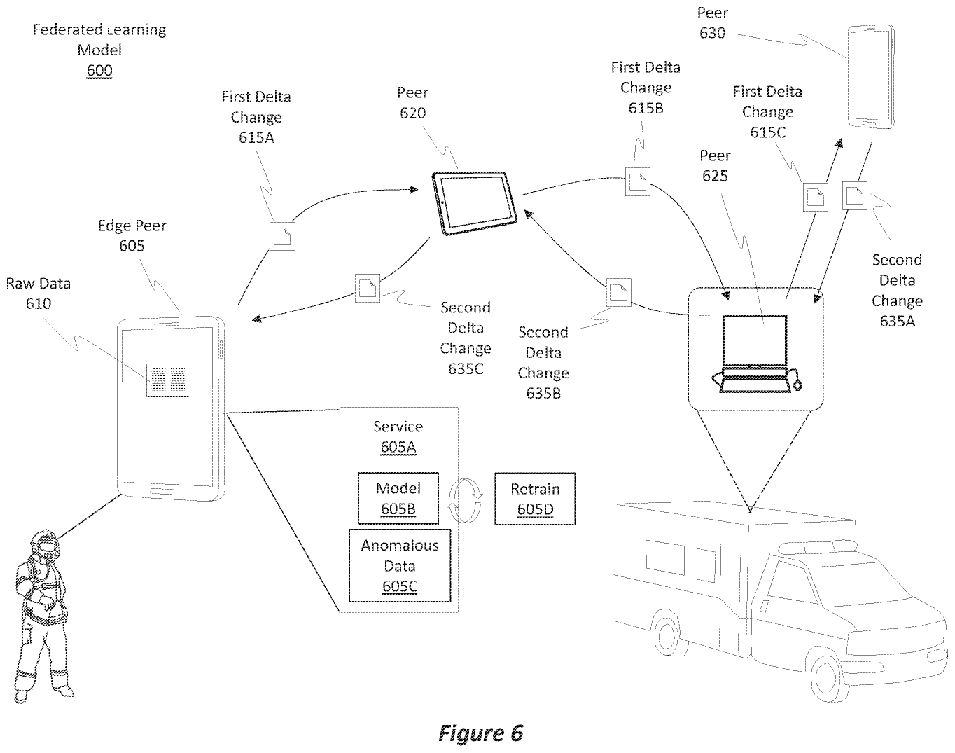

FIG. 6 shows an example of a federated learning model 600 in which an edge peer 605 includes a service 605A and a model 605B. The federated learning model occurs when an edge peer hosts the model as opposed to an intermediary peer or a big peer.

Model 605B operates on raw data 610 that is accessed and/or generated by the edge peer 605. Model 605B analyzes the raw data 610 and detects anomalous data 605C. Because model 605B is unable to resolve the anomaly, input from an SME is desired. Thus, the embodiments identify or select a peer of an SME and transmit the anomalous data 605C to that peer.

By way of further clarification, service 605A adds a new entry into its local version of the P2P mesh network database. This new entry constitutes a first delta change to the database. The other local versions of the database are to be similarly updated.

To illustrate, edge peer 605 propagates first delta change 615A to another peer 620. Peer 620 transmits first delta change 615B to peer 625. Peer 625 transmits first delta change 615C to peer 630, which is the peer of the selected SME. The local version of the database on peer 630 is updated to include the first delta change 615C, and the other local versions of the database on the other peers are similarly updated.

The SME reviews the anomalous data and provides label data. The local version of the database on the peer 630 is then further updated to incorporate the label data from the SME, thereby generating a second delta change. Peer 630 then propagates the second delta change 635A to peer 625. Peer 625 propagates the second delta change 635B to peer 620, which transmits second delta change 635C to edge peer 605. The local version of the database on edge peer 605 is updated to incorporate the second delta change 635C. Additionally, the model 605B is retrained (as shown by retrain 605D) based on the newly acquired label data.

Thus, in the example shown in FIG. 6, an edge peer hosts the model 605B. That model 605B operates at the edge of the P2P mesh network and is able to analyze data and detect anomalies. Notice, in FIG. 6, after the peer that hosts the model identifies the anomaly, only the anomalous data is transmitted through the P2P mesh network; the raw data is not transmitted after being operated on by the model. The embodiments improve efficiency of the network by reducing the amount of data that is transmitted between the peers.

### Connectivity Outside of the Cloud

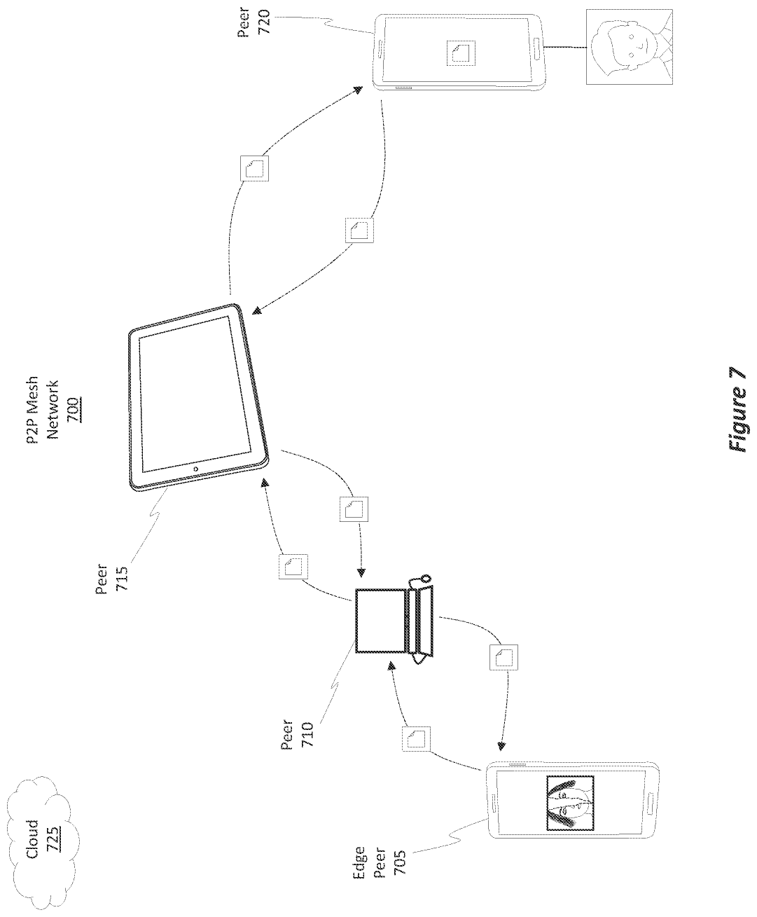

FIG. 7 shows an example P2P mesh network 700 that includes peers 705, 710, 715, and 720. These peers transmit database delta changes to each other in the manner described previously.

In this particular example, notice how none of the peers are connected to the cloud 725, suggesting that none of them have Internet connectivity, at least during the time period in which the delta changes are being transmitted. Despite not having Internet connectivity or cloud connectivity, the peers are still able to communicate with one another and transmit updates back and forth, as described earlier. Thus, in some scenarios, the propagation of data, including anomaly data, can be performed even when no WAN connection exists for any of the peers in the P2P mesh network 700.

### Alerting an SME

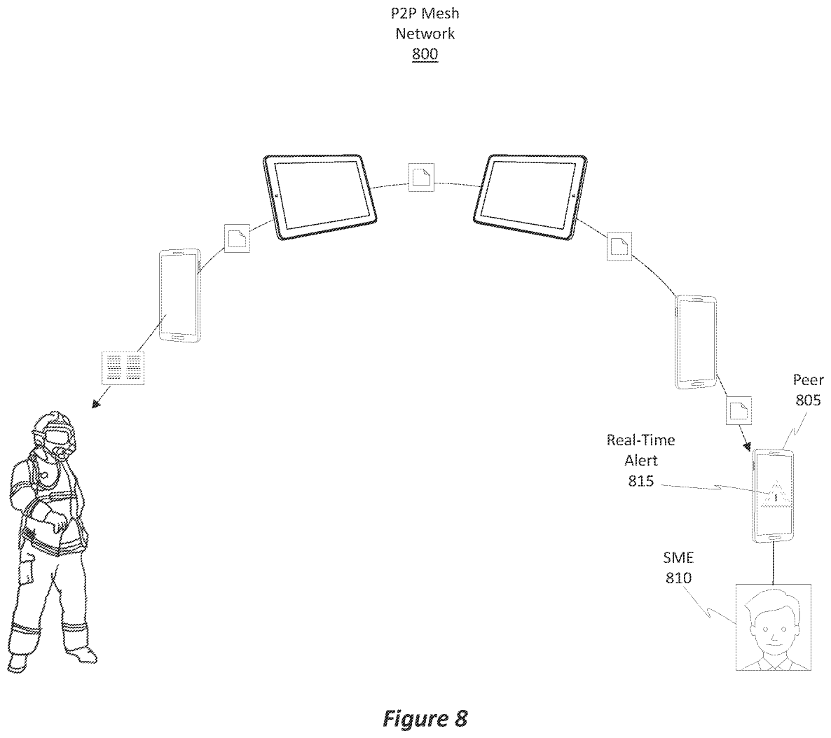

FIG. 8 shows an example P2P mesh network 800 that operates in the manner discussed with respect to the other figures. One objective of the disclosed embodiments is to provide anomaly data to an SME as quickly and efficiently as possible so the SME can resolve that anomaly by providing label data. To do so, some embodiments trigger an alert on the SME's peer when the anomaly is received, or rather, when the database delta change or update is received and incorporated.

FIG. 8 shows a peer 805 of an SME 810. In this example scenario, delta changes are being propagated through the network. Eventually, peer 805 receives the delta change, which corresponds to anomaly data. It is desirable to notify the SME 810 regarding the anomaly. Thus, some embodiments trigger a real-time alert 815 on the peer 805 to notify the SME 810 that his/her input is desired. The real-time alert 815 may include any kind of alert. In some cases, the alert includes an audible alarm, a flashing screen, a call, a text message, a vibration, or any other alert that is designed to call the SME's attention to his/her peer. Combinations of the above can also be performed.

### Quorum Consensus

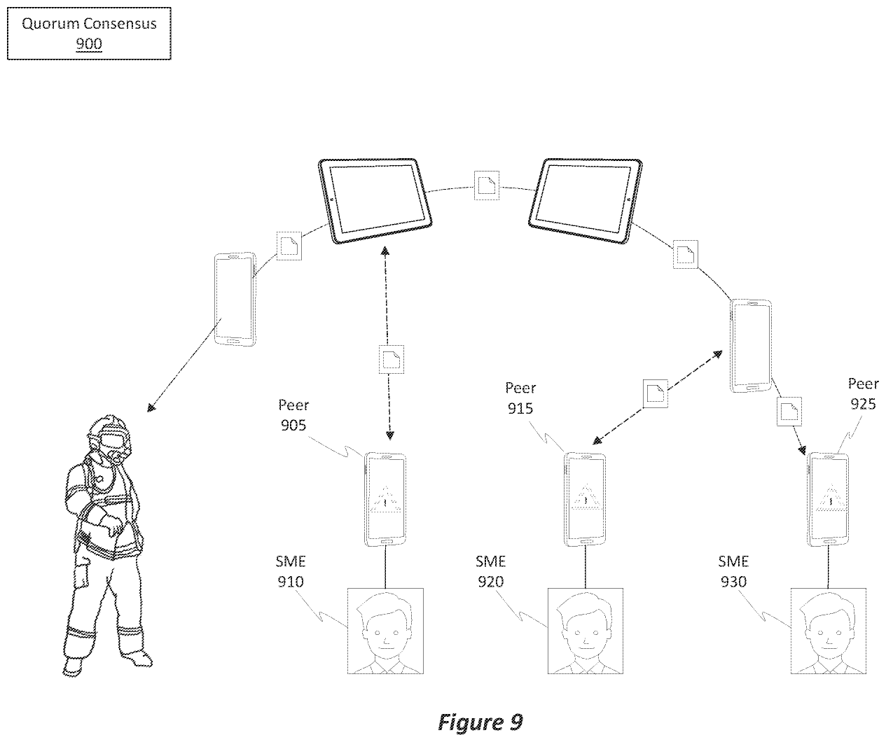

As shown in FIG. 9, some embodiments may require a quorum consensus 900 with respect to label data provided for an anomaly. To illustrate, FIG. 9 shows how anomaly data is transmitted to multiple peers corresponding to multiple SMEs. Peer 905 is associated with SME 910; peer 915 is associated with SME 920; and peer 925 is associated with SME 930. Some embodiments require a majority, a plurality, or a threshold percentage of a quorum to agree on label data prior to allowing the label data to be attributed to the anomaly.

For example, a quorum may be made of 2, 3, 4, 5, 6, 7, 8, 9, 10, or perhaps even more than 10 SMEs. The anomaly data may be delivered to each member of the quorum. Some embodiments may require a threshold number of SMEs to agree on label data that is to be attributed to the anomaly. If no threshold level of agreement is reached, then some embodiments may refrain from providing label data to the anomaly. Alternatively, if no threshold level of agreement is reached, the embodiments may attempt to identify different SMEs to send the anomaly for their input.

In some cases, the inputs from the SMEs are received by the service, and the service is the entity that determines whether a sufficient level of agreement has been reached. If so, then the service may permit the provided label data to then be used by the model for retraining. In other cases, the consensus may be determined in a more distributed manner, such as by each peer receiving delta changes to the P2P mesh network database from the other SME peers, and each peer may determine whether a consensus has been reached.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

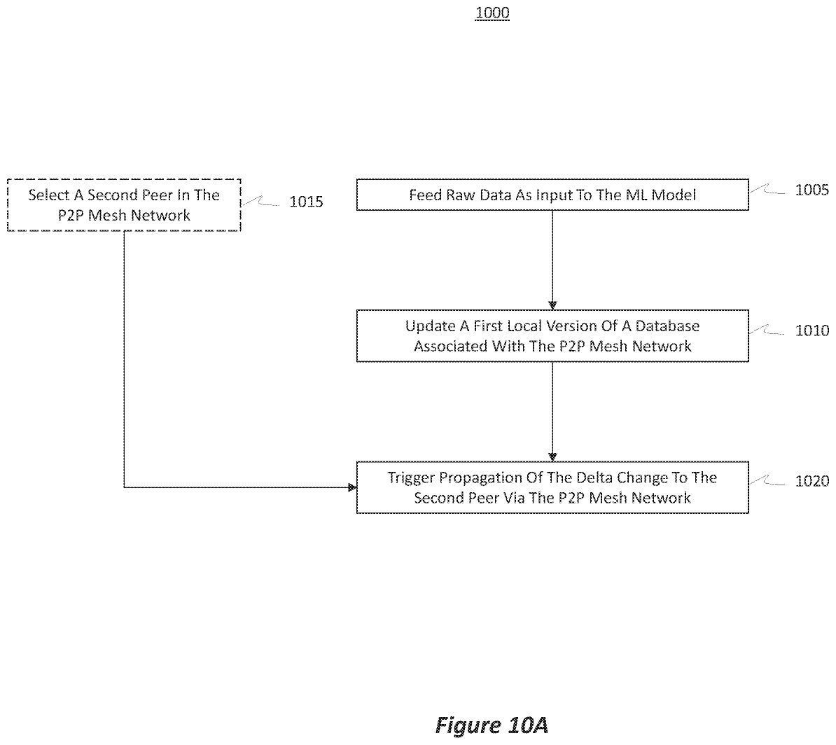

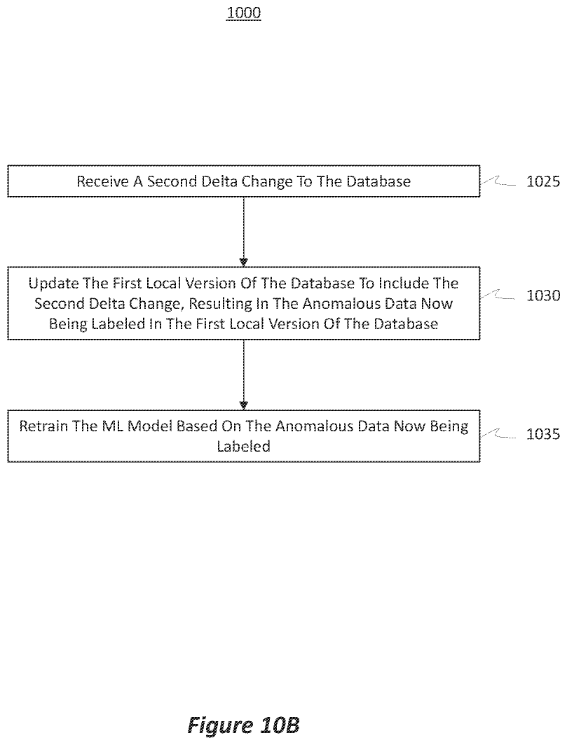

Attention will now be directed to FIGS. 10A and 10B, which illustrate flowcharts of an example method 1000 for facilitating active learning of a machine learning (ML) model, which is hosted on a first peer included in a peer-to-peer (P2P) mesh network. Method 1000 is implemented by that first peer. As one example, intermediary peer 310 of FIG. 3 may be representative of this first peer. Notice, intermediary peer 310 is hosting a model 325A, which is representative of the ML model mentioned above. In some implementations, service 325 of the intermediary peer 310 may be implementing the method acts of method 1000.

Method 1000 includes an act (act 1005) of feeding raw data as input to the ML model. Optionally, the raw data may be one or more of image data, audio data, video data, or text data.

For instance, with reference to FIG. 3, the raw data 320 is fed as input to the model 325A. The ML model identifies a certain portion of the raw data as being anomalous data, such as anomalous data 325B of FIG. 3.

The raw data may be received from a different peer in the P2P mesh network, such as a third peer. The first peer is connected to the third peer via a short-range wireless network connection.

In FIG. 10A, act 1010 includes updating a first local version of a database (e.g., database 410 of FIG. 4) associated with the P2P mesh network. The first local version of the database is hosted by the first peer. The updating process includes adding a new entry to the first local version of the database. The new entry is reflective of the anomalous data, and the new entry constitutes a delta change to the database. With reference to FIG. 3, the first delta change 330A is representative of the delta change mentioned in act 1010.

Some embodiments include an act (act 1015) of selecting a second peer in the P2P mesh network. This second peer is associated with a targeted SME who is determined to be able to provide label data for the anomaly. Stated differently, the second peer is selected to receive the delta change based on a determination that a user of the second peer is identified as having a threshold level of probability of being able to provide the label data for the anomalous data as a part of an active learning event. In some cases, a broker is tasked with selecting the second peer to receive the delta change. The broker analyzes metadata associated with the raw data to determine that the second peer is associated with a subject matter expert corresponding to the metadata.

Act 1020 then includes triggering propagation of the delta change to the second peer in the P2P mesh network. Notably, the delta change, not the raw data, is propagated to the second peer.

Also, the second delta change may be propagated to one or more other peers included in the P2P mesh network, resulting in synchronization of corresponding local versions of the database that are respectively hosted by peers in the P2P mesh network. Optionally, it may be the case that a set of peers in the P2P mesh network omit Internet connectivity at least during a time when the second delta change is being propagated to the set of peers. In some cases, one or more of the peers is at least temporarily not connected to a WAN, such as the Internet.

It should be noted how in some implementations, the anomalous data is anonymized to remove personally identifiable information (PII). Consequently, the delta change also omits PII. The PII can include any type of identifying information, such as, but not limited to, a username, gender, age, date of birth, address, IP address, device name, MAC address, usage trend, telecommunications carrier name, and so on.

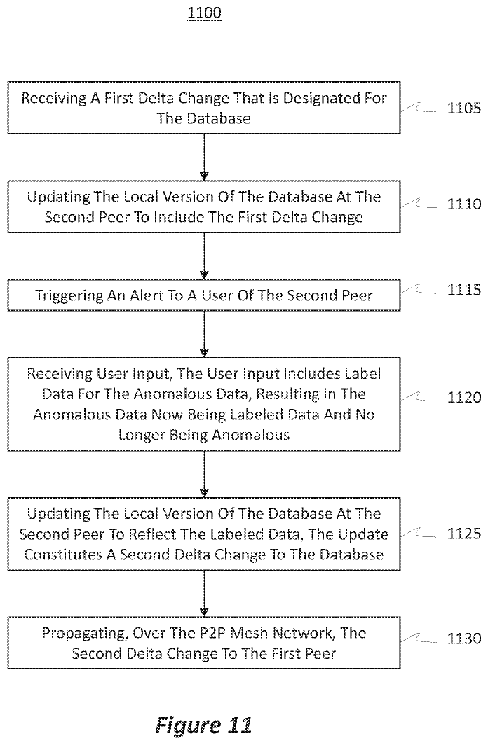

Method 1000 continues in FIG. 10B. Prior to turning to FIG. 10B, however, attention will be directed to FIG. 11, which illustrates the operations performed at the second peer when the second peer receives the delta change.

FIG. 11 shows a flowchart of an example method 1100 for facilitating active learning of a machine learning (ML) model, which is hosted on a first peer included in a peer-to-peer (P2P) mesh network. In this scenario, method 1100 is implemented by a second peer in the P2P mesh network. The second peer comprises a local version of a database associated with the P2P mesh network. Whereas method 1000 of FIGS. 10A and 10B was implemented, for example, by intermediary peer 310, method 1100 of FIG. 11 is implemented by peer 315, which is the peer device of the SME tasked with providing label data for the anomalous data 325B of FIG. 3.

Act 1105 includes receiving, over the P2P mesh network and from the first peer, a first delta change that is designated for the database. The first delta change corresponds to the delta change mentioned with respect to act 1020 of FIG. 10A. The first delta change includes a new entry that is addable to the local version of the database at the second peer, and the first delta change corresponds to data that has been identified as being anomalous data. The second peer is connected to the first peer over a short-range wireless network connection.

Act 1110 includes updating the local version of the database at the second peer to include the first delta change. This update may involve adding a new database entry to the database.

Act 1115 includes triggering an alert to a user of the second peer. This user is an SME. The SME is selected based on a determined likelihood that this SME, as well as potentially one or more other SMEs, can provide proper label data for the anomaly. For instance, the selected SME may have a technical background that corresponds to the metadata of the raw data and/or of the anomaly. The selected SME may have a documented history of being able to resolve past anomalies that may be similar to the current anomaly. The selected SME may be one who other SMEs have identified as potentially being able to resolve the current anomaly.

Act 1120 includes receiving user input from the SME. The user input includes label data for the anomalous data, resulting in the anomalous data now being labeled data and no longer being anomalous.

Act 1125 includes updating the local version of the database at the second peer to reflect the labeled data. This updating process constitutes a second delta change to the database.

Act 1130 then includes propagating, over the P2P mesh network, the second delta change to the first peer. The second delta change is configured to enable a different local version of the database, which is on the first peer, to be updated based on the second delta change. Also, the second delta change is further configured to enable the ML model on the first peer to be retrained based on the labeled data.

In some cases, method 1100 may further include propagating, over the P2P mesh network, the second delta change to a third peer. This act results in triggering an update to another local version of the database on that third peer.

Turning now to FIG. 10B, act 1025 includes receiving, over the P2P mesh network, a second delta change to the database. The second delta change originates from the second peer and includes label data for the anomalous data. This second delta change corresponds to the second delta change mentioned with respect to act 1130. Similarly, second delta change 335A of FIG. 3 is representative of the second delta change.

Act 1030 includes updating the first local version of the database to include the second delta change, resulting in the anomalous data now being labeled in the first local version of the database. As a result of the anomalous data now being labeled, the anomalous data is no longer determined to be anomalous.

Act 1035 then includes retraining the ML model based on the anomalous data now being labeled. The process of retraining the ML model involves updating the deployed ML model using new data, such as the label data for the anomaly.

In some scenarios, during a time period spanning from when the raw data is fed into the ML model to when the ML model is retrained, the first peer omits a wireless connection to a wide area network (WAN). Stated differently, the first peer is at least temporarily not connected to the WAN. For instance, one or more of the peers may not, at least temporarily though perhaps permanently, have a direct connection with the Internet.

It should be noted how data transmitted over the P2P mesh network is integrity protected via a virtual private network (VPN). This VPN is established between peers of the P2P mesh network.

Optionally, the first peer may be an edge peer in the P2P mesh network. Consequently, retraining the ML model is performed in a federated learning manner. As another option, the first peer may be an intermediary peer in the P2P mesh network, and the first peer resides outside of a cloud environment. Alternatively, the first peer may be a big peer residing inside of the cloud environment.

Accordingly, the disclosed embodiments bring about numerous benefits to the technical field of active learning. Beneficially, the embodiments reduce latency and lag times that were inherent to previous active learning systems. Now, anomalies can be transmitted to one or more SMEs in a quick and efficient manner. ML models can also be readily retrained based on the data provided form the SMEs.

### Example Computer/Computer Systems

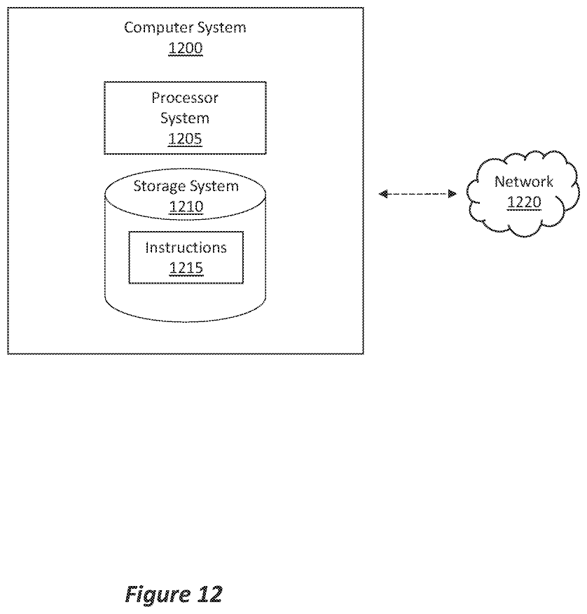

Attention will now be directed to FIG. 12 which illustrates an example computer system 1200 that may include and/or be used to perform any of the operations described herein. Computer system 1200 may take various different forms. For example, computer system 1200 may be embodied as a tablet, a desktop, a laptop, a mobile device, or a standalone device, such as those described throughout this disclosure. Computer system 1200 may also be a distributed system that includes one or more connected computing components/devices that are in communication with computer system 1200. Computer system 1200 can be implemented as any of the peers described herein. Computer system 1200 can also implement service 325 of FIG. 3.

In its most basic configuration, computer system 1200 includes various different components. FIG. 12 shows that computer system 1200 includes a processor system 1205 that includes one or more processor(s) (aka a “hardware processing unit”) and a storage system 1210.

Regarding the processor(s) of the processor system 1205, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1200. The different components, modules, engines, and services described herein may be implemented as objects or processors that execute on computer system 1200 (e.g. as separate threads).

Storage system 1210 may include physical system memory, which may be volatile, non-volatile, or some combination of the two. The term “memory” may also be used herein to refer to non-volatile mass storage such as physical storage media. If computer system 1200 is distributed, the processing, memory, and/or storage capability may be distributed as well.

Storage system 1210 is shown as including executable instructions 1215. The executable instructions 1215 represent instructions that are executable by the processor(s) of processor system 1205 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1200 may also be connected (via a wired or wireless connection) to external sensors (e.g., one or more remote cameras) or devices via a network 1220. For example, computer system 1200 can communicate with any number devices or cloud services to obtain or process data. In some cases, network 1220 may itself be a cloud network. Furthermore, computer system 1200 may also be connected through one or more wired or wireless networks to remote/separate computer systems(s) that are configured to perform any of the processing described with regard to computer system 1200.

A “network,” like network 1220, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1200 will include one or more communication channels that are used to communicate with the network 1220. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for facilitating active learning of a machine learning (ML) model, which is hosted on a first peer included in a peer-to-peer (P2P) mesh network, said method being implemented by the first peer and comprising:
feeding raw data as input to the ML model, wherein the ML model identifies a certain portion of the raw data as being anomalous data;
updating a first local version of a database associated with the P2P mesh network, wherein the first local version of the database is hosted by the first peer, wherein said updating includes adding a new entry to the first local version of the database, the new entry being reflective of the anomalous data, and wherein the new entry constitutes a delta change to the database;
triggering propagation of the delta change to a second peer in the P2P mesh network;
receiving, over the P2P mesh network, a second delta change to the database, wherein the second delta change originates from the second peer and includes label data for the anomalous data;
updating the first local version of the database to include the second delta change, resulting in the anomalous data now being labeled in the first local version of the database; and
retraining the ML model based on the anomalous data now being labeled.

2. The method of claim 1, wherein the raw data is received from a third peer in the P2P mesh network.

3. The method of claim 2, wherein the first peer is connected to the third peer via a short-range wireless network connection.

4. The method of claim 1, wherein, during a time period spanning from when the raw data is fed into the ML model to when the ML model is retrained, the first peer is at least temporarily not connected to a wide area network (WAN).

5. The method of claim 1, wherein the raw data is one of image data, audio data, video data, or text data.

6. The method of claim 1, wherein the second peer is selected to receive the delta change based on a determination that a user of the second peer is identified as having a threshold level of probability of being able to provide the label data for the anomalous data as a part of an active learning event.

7. The method of claim 1, wherein a broker is tasked with selecting the second peer to receive the delta change, and wherein the broker analyzes metadata associated with the raw data to determine that the second peer is associated with a subject matter expert corresponding to the metadata.

8. The method of claim 1, wherein the second delta change is propagated to one or more other peers included in the P2P mesh network, resulting in synchronization of corresponding local versions of the database that are respectively hosted by those one or more other peers in the P2P mesh network.

9. The method of claim 8, wherein a set of peers in the P2P mesh network is at least temporarily not connected to an Internet at least during a time when the second delta change is being propagated to the set of peers.

10. The method of claim 1, wherein, as a result of the anomalous data now being labeled, the anomalous data is no longer determined to be anomalous.

11. A computer system that facilitates active learning of a machine learning (ML) model, the computer system being a first peer in a peer-to-peer (P2P) mesh network, the computer system hosting the ML model, the computer system comprising:
a processor system; and
a storage system comprising instructions that are executable by the processor system to cause the computer system to:
feed raw data as input to the ML model, wherein the ML model identifies a certain portion of the raw data as being anomalous data;
update a first local version of a database associated with the P2P mesh network, wherein the first local version of the database is hosted by the first peer, wherein said updating includes adding a new entry to the first local version of the database, the new entry being reflective of the anomalous data, and wherein the new entry constitutes a delta change to the database;
select a second peer in the P2P mesh network;
trigger propagation of the delta change to the second peer via the P2P mesh network;
receive, over the P2P mesh network, a second delta change to the database, wherein the second delta change originates from the second peer and includes label data for the anomalous data;
update the first local version of the database to include the second delta change, resulting in the anomalous data now being labeled in the first local version of the database; and
retrain the ML model based on the anomalous data now being labeled.

12. The computer system of claim 11, wherein the delta change, not the raw data, is propagated to the second peer.

13. The computer system of claim 12, wherein the raw data is received from a third peer and is transmitted over the P2P mesh network.

14. The computer system of claim 11, wherein data transmitted over the P2P mesh network is integrity protected via a virtual private network (VPN) that is established between peers of the P2P mesh network.

15. The computer system of claim 11, wherein the anomalous data is anonymized to remove personally identifiable information (PII), such that the delta change also omits PII.

16. The computer system of claim 11, wherein the first peer is an edge peer in the P2P mesh network such that retraining the ML model is performed in a federated learning manner.

17. The computer system of claim 11, wherein (i) the first peer is an intermediary peer in the P2P mesh network, and the first peer resides outside of a cloud environment, or, alternatively, (ii) the first peer is a big peer residing inside of the cloud environment.

18. A method for facilitating active learning of a machine learning (ML) model, which is hosted on a first peer included in a peer-to-peer (P2P) mesh network, said method being implemented by a second peer in the P2P mesh network, the second peer comprising a local version of a database associated with the P2P mesh network, said method comprising:
receiving, over the P2P mesh network and from the first peer, a first delta change that is designated for the database, wherein the first delta change includes a new entry that is addable to the local version of the database at the second peer, and wherein the first delta change corresponds to data that has been identified as being anomalous data;
updating the local version of the database at the second peer to include the first delta change;
triggering an alert to a user of the second peer;
receiving user input, wherein the user input includes label data for the anomalous data, resulting in the anomalous data now being labeled data and no longer being anomalous;
updating the local version of the database at the second peer to reflect the labeled data, wherein said updating constitutes a second delta change to the database; and
propagating, over the P2P mesh network, the second delta change to the first peer, wherein:
the second delta change is configured to enable a different local version of the database, which is on the first peer, to be updated based on the second delta change, and
the second delta change is further configured to enable the ML model on the first peer to be retrained based on the labeled data.

19. The method of claim 18, wherein the second peer is connected to the first peer over a short-range wireless network connection.

20. The method of claim 18, wherein the method further includes propagating, over the P2P mesh network, the second delta change to a third peer, triggering an update to another local version of the database on that third peer.
